(19) United States
(12) Patent Application Publication
(10) Pub. No.: US 2001/0019587 A1
(43) Pub. Date: Sep. 6, 2001

(54) Image transmission system, viewing system for received images, and image transmission viewing system with TV conference function

(75) Inventors: Masayuki Hashimoto, Saitama (JP); Atsushi Koike, Tokyo (JP); Shuichi Matsumoto, Tokyo (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: DDI CORPORATION, Tokyo (JP)

(21) Appl. No.: 09/785,305

(22) Filed: Feb. 20, 2001

(30) Foreign Application Priority Data
Mar. 3, 2000 (JP) 2000-59153

(51) Int. Cl. H04N 7/12

(52) U.S. Cl. 375/240.19; 375/240.11; 348/398.1

(57) ABSTRACT

According to the present invention, an image transmitter apparatus which has a data structure suited for receiving a request for diagnosis over images and a received image viewing apparatus arranged for displaying desired images a received side are provided.

In an encoder transmitter, an image converter divides each medical image data of CT, MRI, or other format into segments and generates files of hierarchically encoded image data. A request file generator generates a request file for the image data which is at a higher level of the DICOM hierarchy category. In a view terminal, a viewer program executor accesses the encoded image data file and the request file saved in a local HD and displays a selection menu of the request file on a display. This allows an assigned expert to readily identify the current case study over the date of reception of its request and easily select another patient for the succeeding case study.

### BACKGROUND OF THE INVENTION

1. Field of the Invention

The present invention relates to an image transmission system, a received image viewing system, and an image transmission viewing system with a TV conference function which are suited for use to assist an action of remote diagnosis over electronically digitized medical images.

2. Description of the Related Art

In common practice, when an expert doctor at one hospital is requested for conducting a particular diagnosis over medical images (of e.g. CT, MRI, or CR format) produced at another hospital, he has to visit the another hospital at given intervals (for example, once a week) for accessing and viewing the medical images. Alternatively, a group of medical images produced at one hospital may be transferred from the image transmitter apparatus over a transmission network to another hospital where they are viewed by an assigned expert for particular diagnosis.

As both the above conventional systems are designed for providing experts with the medical images for particular diagnosis, they fail to create a specific scheme for allowing the experts to view a large volume of image data, for example, produced in one full week. Also, the latter system only provides the same data environment as at the original location in a distanced hospital which is transferred the medical images.

As the technology of imaging devices have been progressed for producing a large volume of image data at a single operation and it is common to accumulate the image data produced in one week, an advanced display system is demanded which can handle and display at high speeds such a great volume of the image data for ease of the particular diagnosis. The demand is also upheld when electronically digitized medical images are produced in a group examination such as in a school and then displayed on a CRT (cathode ray tube) for the particular diagnosis.

DICOM (Digital Imaging and Communications in Medicine) is an operating standard developed in the U.S.A. for storage and management of electronically digitized medical images. In DICOM, a communications protocol and a file format are standardized for storage and management of the medical images. The medical image data file has logically a four-level category hierarchy. “Patient” is the highest level containing a plurality of test units called “Study”. The Study category includes one or more “Series” categories showing a series of photography, each consisting of at least one “Image” file.

It is hence desired to develop a DICOM viewer (an image display terminal) which can display at a high speed a group of images reproduced from the DICOM data for ease of the particular diagnosis.

The four-level hierarchy of DICOM is based on a workflow of radiologist's diagnosis but does not involves the diagnosis through simply viewing the medical images. More specifically, as all the medical images to be examined for the particular diagnosis have been received and saved in an image database, a desired case study can be identified by their relevant data including the date of reception, the name of a patient, and the name of a requesting hospital. It is however impossible to know in which (when) request the current case study is included and which case studies are included in the same request. When two or more requests are received from different hospitals or any request is mixed with the preceding requests, the current case study may hardly be identified over the date of reception of its request and the name of a requesting hospital.

Since a conventional DICOM viewer is generally operated over the Study category, the expert has to open a Study selection menu to select the Study case of a next patient whenever the case Study of a patient is finished during the viewing of two or more patients (case studies). This may decline the operability of the system.

Moreover, the conventional DICOM viewer initiates the display of images of a desired case study only when all the images of the case study have been transferred from a hard disk to a working memory. In case that the case study carries a large amount of image data or includes the images of a large size, the transfer of the image data may take a considerable length of time. This will pull the action of disk access whenever the action of diagnosis is shifted from one patient to another, hence inhibiting the expert from viewing without delay.

### SUMMARY OF THE INVENTION

It is an object of the present invention to provide an image transmitter apparatus which has a data structure suited for receiving a request for the particular diagnosis while eliminating the foregoing disadvantages of prior art. It is another object of the present invention to provide a received image viewing apparatus capable of displaying desired images favorably at the received side. It is a further object of the present invention to provide an image transmission viewing apparatus with a TV conference function capable of exchanging dialogs for the diagnosis while viewing relevant images at both sides.

As the first feature of the present invention, an image transmitter apparatus comprises an image converter for generating files of hierarchically encoded image data; a request file generator for generating a request file for the image data which is at a higher level of the DICOM hierarchy; and a file transferor for releasing the encoded image data files generated by the image converter and the request file generated by the request file generator.

As the second feature of the present invention, a received image viewing apparatus comprises a memory means for storing files of encoded image data generated by hierarchically encoding image data and a request file for the image data which is at a higher level of the DICOM hierarchy; a means for analyzing the request file read out from the memory means; and a displaying means for displaying a selection view of the request file to show the DICOM hierarchical category data assigned to the request file.

According to the first and second features of the present invention, an expert doctor assigned for diagnosis can readily identify in which (when) request the current case study is included and easily select another patient for the succeeding case study. Also, desired segments of the image can be easily and promptly displayed at a higher degree of resolution.

As the third feature of the present invention, the real-time two-way image transmitting means with a TV conference function is linked between the image transmitter apparatus and the received image viewing apparatus. This allows the diagnosis to be conducted through exchanging dialogs at real time between the image transmitter apparatus and the received image viewing apparatus while monitoring the medical images at both sides.

### BRIEF DESCRIPTION OF THE DRAWINGS

FIG. 1 is a block diagram schematically showing a system according to one embodiment of the present invention;

FIG. 2 is a block diagram showing a detailed arrangement of an image converter shown in FIG. 1;

FIG. 3 is a diagram showing a hierarchy structure of each file of the system of the present invention;

FIG. 4 is a view of a display screen illustrating a request file;

FIG. 5 is a schematic explanatory view showing a process of dividing an original image into segments;

FIG. 6 is a schematic explanatory view showing an encoding process according to the present invention;

FIG. 7 is a flowchart showing the action of a viewer terminal according to the present invention;

FIG. 8 is a flowchart showing a branch of the action shown in FIG. 7;

FIG. 9 is a view of a display screen illustrating the selection of a request file;

FIG. 10 is a view of a display screen illustrating the DICOM hierarchy structure;

FIG. 11 is a view of a display screen illustrating the DICOM hierarchy structure and low-resolution images;

FIG. 12 is a view of a display screen illustrating an enlarged high-resolution image; and

FIG. 13 is a block diagram showing a system with a TV conference function according to another embodiment of the present invention.

### DETAILED DESCRIPTION OF THE PREFERRED EMBODIMENTS

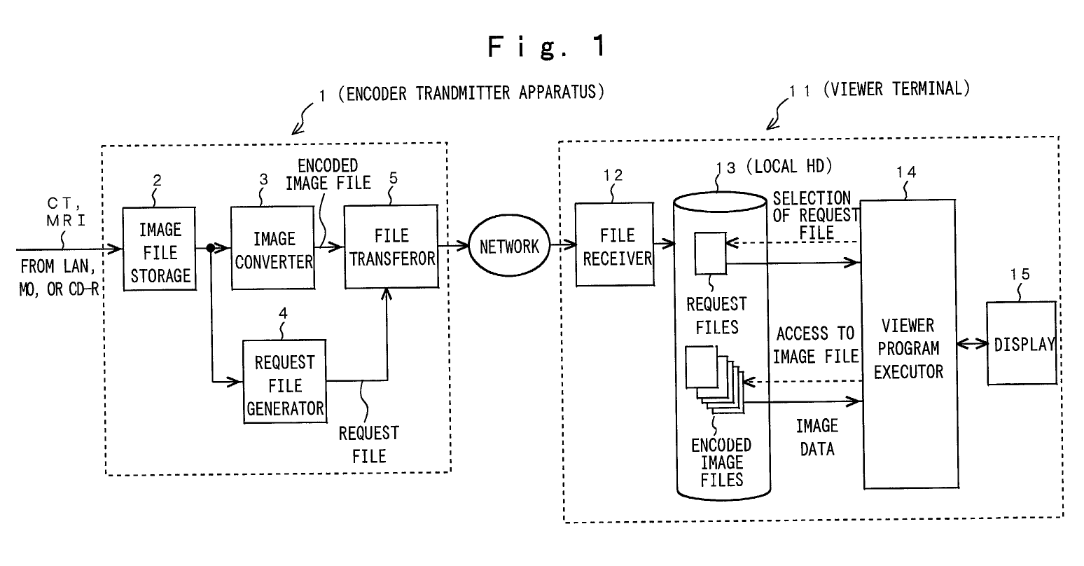

The present invention will be described in more detail referring to the relevant drawings. FIG. 1 is a block diagram schematically showing a system according to one embodiment of the present invention.

An encoder transmitter apparatus 1 comprises an image file storage 2, an image converter 3, a request file generator 4, and a file transferor 5. The image file storage 2 saves digitized images of CT, MRI, or like desired to be examined by the department B which may be either transferred over a LAN from one department A of a hospital or read out from an MO or CD-R disk. The image converter 3 converts the digitized images of each DICOM file retrieved from the image file storage 2 into a specifically encoded form of the file. The request file generator 4 generates a request file including the date of request for the diagnosis as a time data, the name of a requesting department as a sender data, the name of the image file as a request file data, and the data of the DICOM hierarchy category (Patient, Study, Series, and Image). The file transferor 5 connects to a viewer terminal 11 in the department B over a network (e.g. ISDN) and transfers the image files and the request file to the viewer terminal 11 using FTP.

The viewer terminal 11 in the department B comprises a file receiver 12 for receiving all the image files and the request file from the network, a local harddisk (referred to as a local HD hereinafter) 13 for storing all the image files and the request file received, a viewer program executor 14 for analyzing the request file, and a display 15 for displaying the images reproduced by the action of the viewer program executor 14.

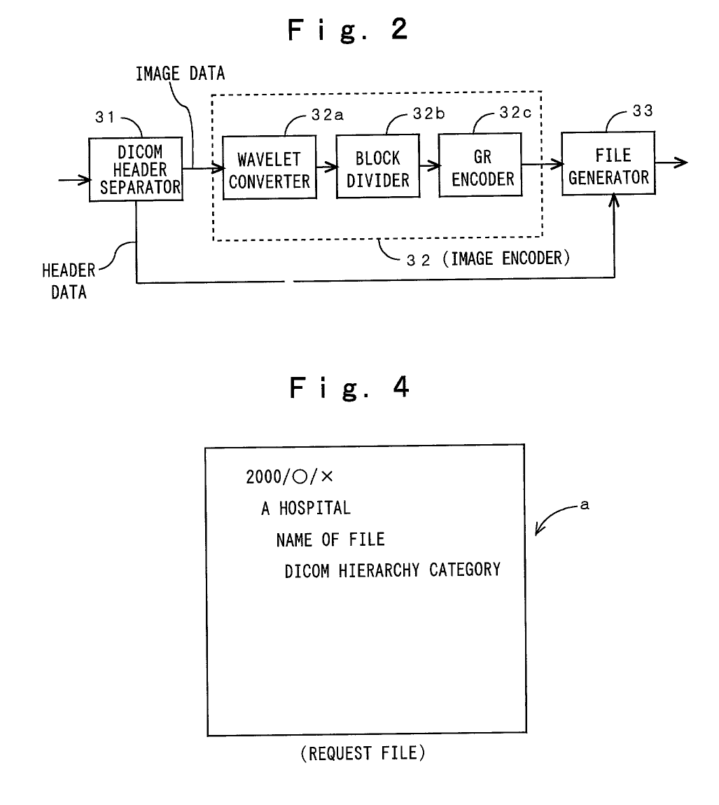

FIG. 2 illustrates a detailed arrangement of the image converter 3 in the encoder transmitter apparatus 1. As shown, the image converter 3 comprises a DICOM header separator 31, an image encoder 32, and a file generator 33. The image encoder 32 consists mainly of a wavelet converter 32a, a block divider 32b, and a GR encoder 32c.

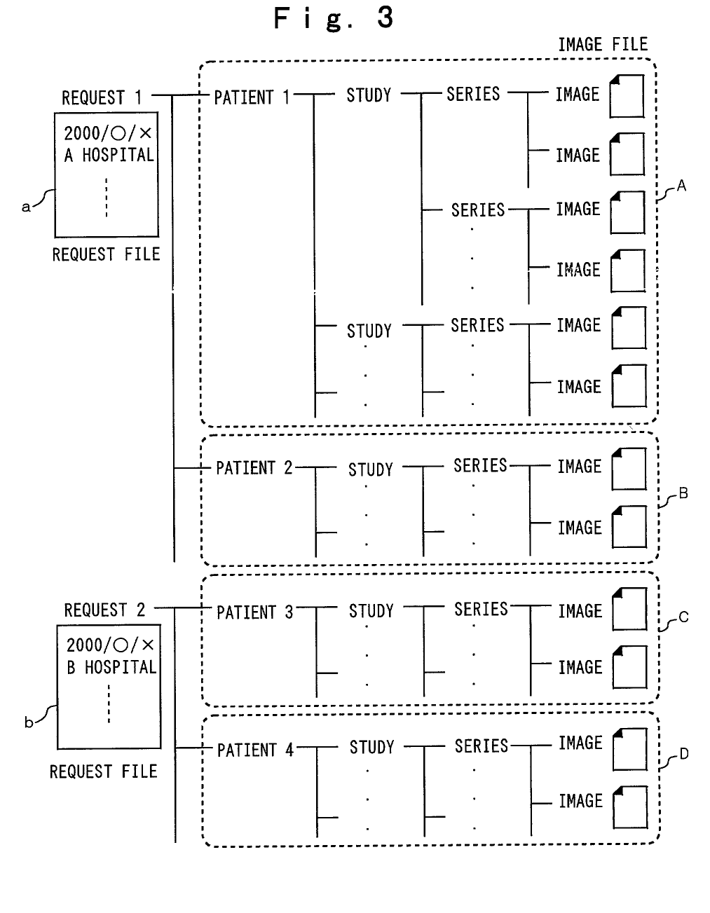

The data structure according to the present invention, which is favorably designed for carrying out a diagnosis through viewing the medical images, is illustrated in FIG. 3. Denoted by A, B, C, and D are image files of the DICOM standard, each file having logically a four-level category hierarchy of Patient, Study, Series, Image. According to the present invention, the request file (a) or (b) is added to the highest level of the hierarchy. FIG. 4 illustrates the request file (a), for example, which carries the date, month and day, of request for the diagnosis, the name of a requesting department, the name of the file, and the DICOM hierarchy category data.

The action of this embodiment having the above arrangement will now be described. The description starts with the action of the encoder transmitter apparatus 1.

The image file storage 2 stores the image data which are received over the LAN from the department A or read out from an MO or CD-R disk and desired to be examined by the department B. The image data include DICOM files or other format files.

In the image converter 3, when the image data read from the image file storage 2 is the DICOM files, their tags (a header data) are separated at the DICOM header separator 31. The remaining of the image data is then transferred to the image encoder 32. The header data separated is transferred to the file generator 33. The image data is subjected to Haar wavelet conversion in the wavelet converter 32a of the image decoder 32 for separation into levels. The frequency region of each level is then divided into blocks by the block divider 32b. Square blocks of the image data are separately encoded in the GR encoder 32c so that a desired block can selectively be decoded. The encoding is carried out adaptively using the Golomb-Rice coding technique which allows simple and high-speed decoding. As a result, each of the block is accompanied with a detection bit, a bit indicating the location of the block, and a parameter of the GR encoder.

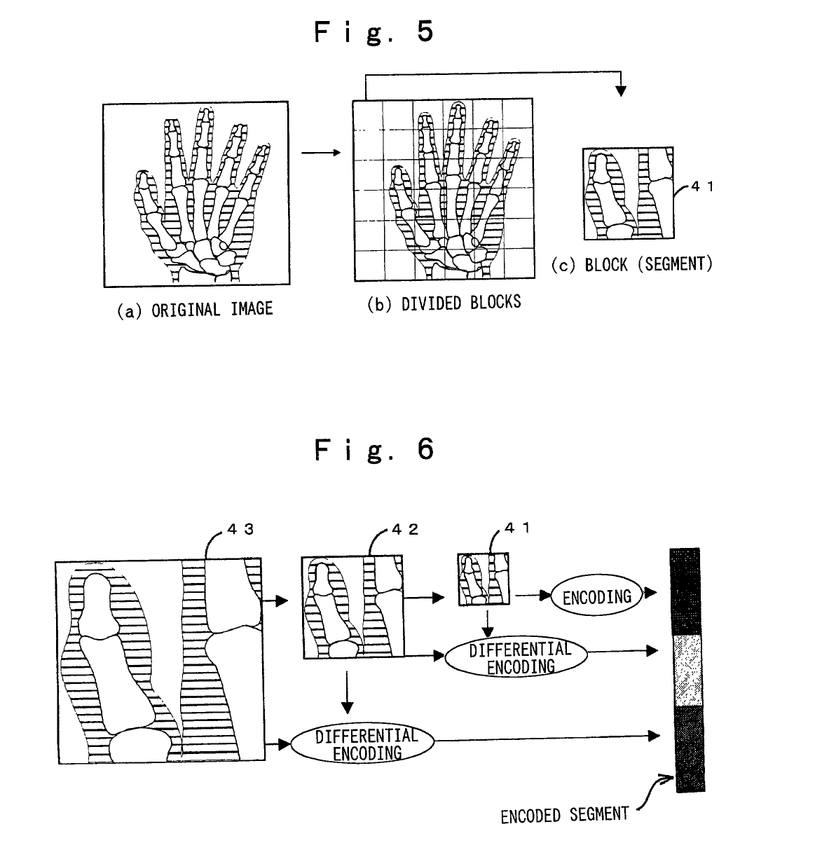

The encoding in the image encoder 32 may be carried out by a manner shown in FIG. 5 which is disclosed in more detail in Japanese Patent Laid-open Publication 2000-41149. As shown in FIG. 5a, the image data (an original image) is divided into blocks (FIG. 5b) and each block shown in FIG. 5c is hierarchically encoded as shown in FIG. 6. More specifically, while the third level image 41 at the lowest degree of resolution is encoded, the second level image 42 at a higher degree of resolution and the first level image 43 at the highest degree of resolution are differentially encoded. According to the encoding manner, the other two images 42 and 43 than the third level image 41 at the lowest degree of resolution are subjected to the differential encoding. This allows the data to be transmitted to be significantly reduced in the volume and the consumption of time as compared with the encoding of all the first to third level images. Also, this encoding manner permits the viewer terminal 11 to promptly decode each desired segment (a block) of the image data at a desired degree of resolution.

In the file generator 33, the header data separated by the DICOM header separator 31 is added with the encoded image data produced by the image encoder 32 to generate an encoded image file. When the image data retrieved from the image file storage 2 is not of the DICOM files, the file generator 33 assigns the encoded image data as an encoded image file.

Next, the request file generator 4 generates a request file such as shown in FIG. 4. The request file is generated when ever the action of diagnos is is demanded. When the image data retrieved from the image file storage 2 is not of the DICOM files, the hierarchical category data is separately added.

The filter transferor 5 (FIG. 1) transfers the encoded image files received from the image converter 3 and the request file generated by the request file generator 4 over the network to the viewer terminal 11 using the FTP (file transfer protocol).

The action of the viewer terminal 11 is explained. The encoded image file and the request file from the network is received by the file receiver 12 and saved in the local HD 13 shown in FIG. 1. All the request files are displayed on the user interface screen by the viewer program executor 14. This allows the expert doctor , who is required for conducting the action of diagnosis at the department B, to view and operate the user interface screen to pick up the medical images to be examined from a number of the image files received from two or more departments or hospitals. In action, when one of the request files is selected on the user interface screen, its related image files are displayed in the hierarchical levels. Accordingly, all the images in each level can instantly be viewed. More specifically, the images at a lower degree of resolution are displayed at a higher speed and when desired, the desired segment of the images can be displayed at their high resolution versions corresponding to their desired hierarchical level. This permits the expert to view and examine details of each image on the display as it demands.

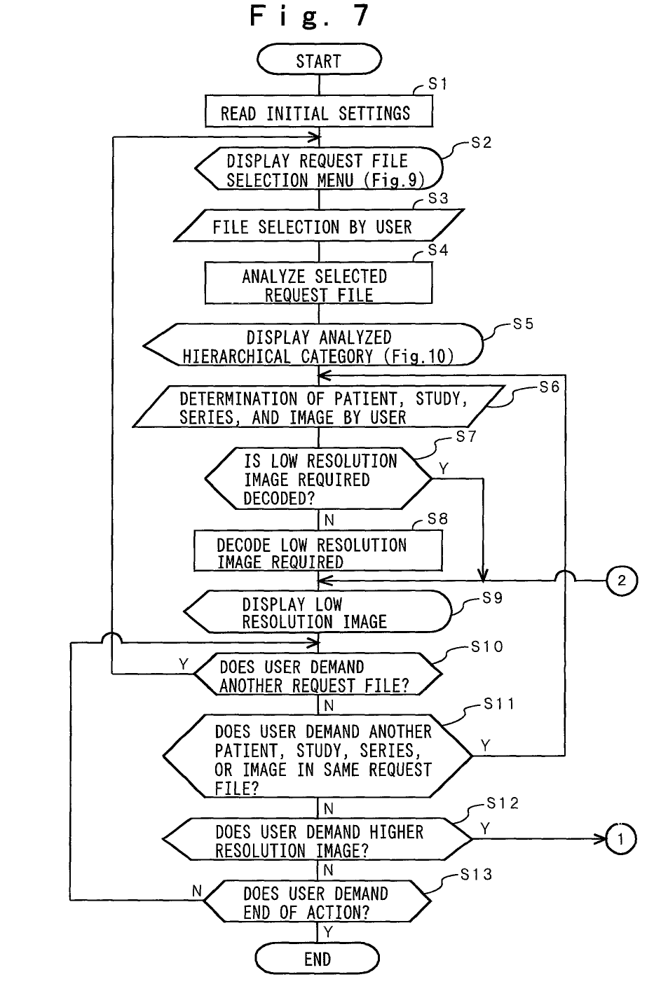

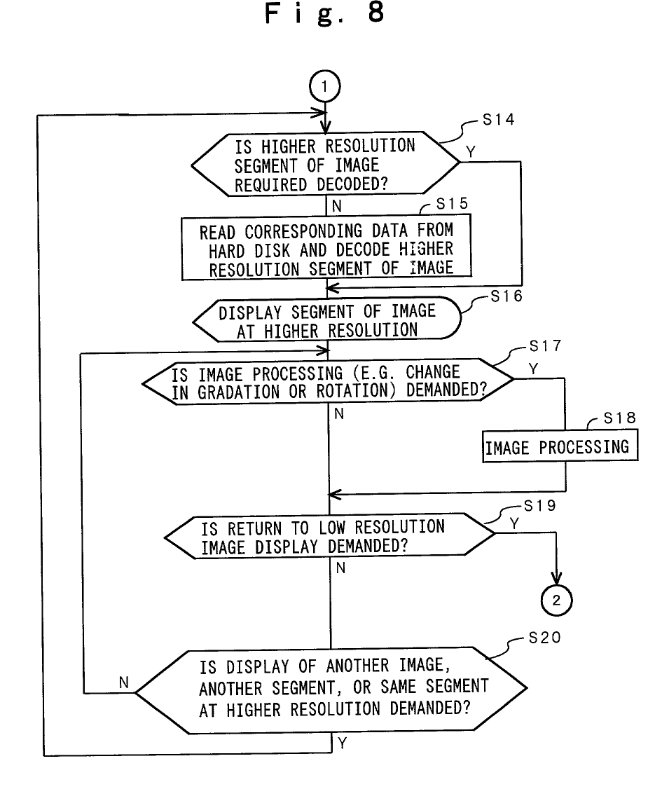

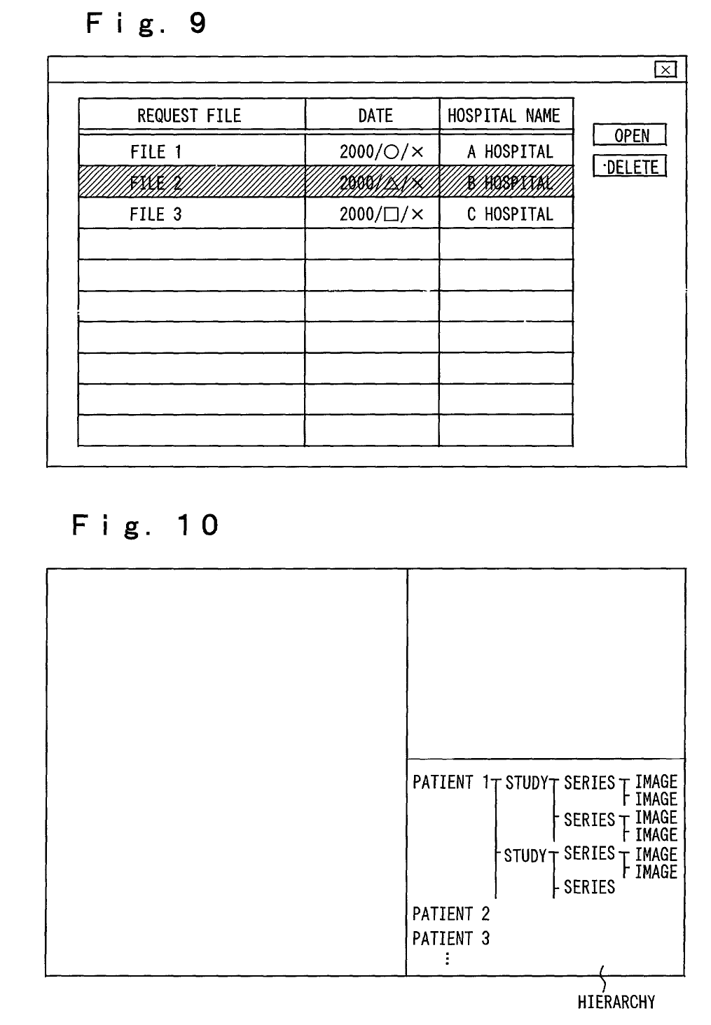

The action of the viewer program executor 14 is explained referring to flowcharts shown in FIGS. 7 and 8. The flowchart starts with Step S1 for initial setting. This is followed by Step S2 where a request file selection menu appears in the user interface screen (referred to as simply a screen hereinafter) on the viewer terminal 11 as shown in FIG. 9. Namely, a list of the request files, the date, and the hospital names is displayed.

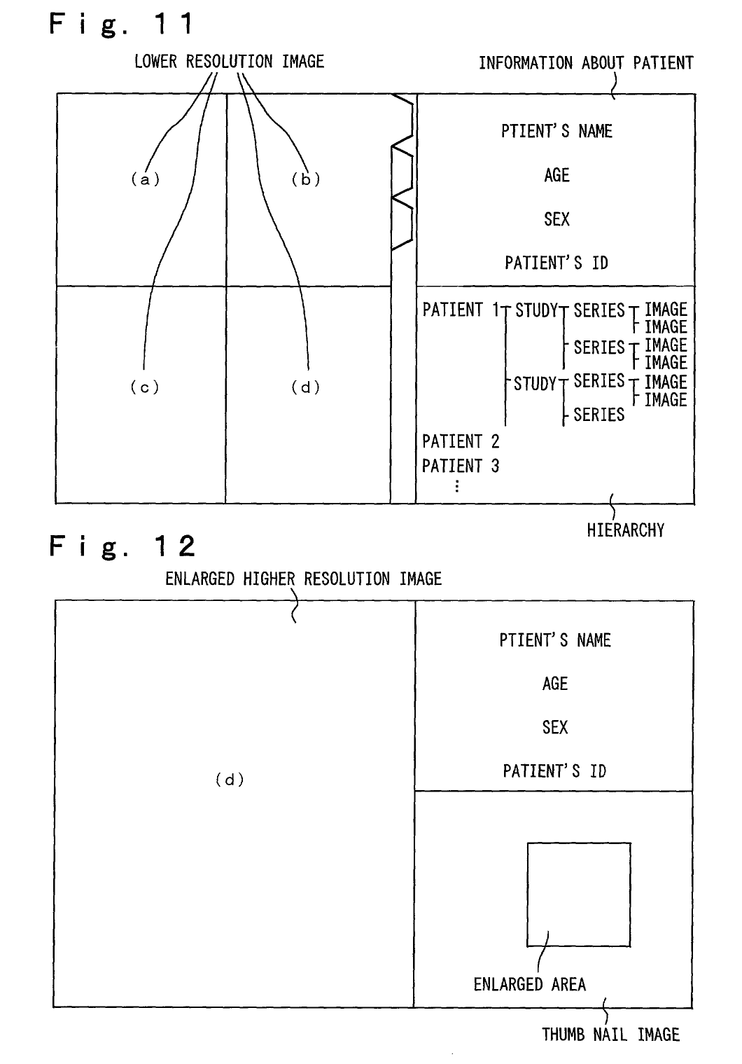

When a desired one of the request files is selected at Step S3, the procedure goes to Step S4 where the selected request file is analyzed. Then, the hierarchy of the selected request file is displayed at Step S5 as shown in FIG. 10. As the Patient, the Study, the Series, and the Image are selectively determined at Step S6, the examination at Step S7 follows. More particularly, it is examined whether a lower resolution segment of the requested image has been already decoded or not. For example, it is judged whether a segment at a lower degree of resolution of the image shown in FIG. 5a has been decoded or not. If not, the procedure advances to Step S8 where the lower resolution segment of the image is decoded. At Step S9, the lower resolution image is displayed in four separate segments (a to d) on the remaining of the screen while the information about a patient including the name and the age is displayed at an upper right region of the screen showing in FIG. 11.

It is examined at Step S10 whether another request file is accessed or not by the user. When it is judged so, the procedure returns back to Step S2 for displaying the request file selection screen shown in FIG. 9. If it is judged “not”, the procedure goes to Step S11 for judging whether or not the other Patient, Study, Series, or Image level in the same request file is demanded by the user. When so, the procedure returns to Step S6. When not, the procedure advances to Step S12. It is judged at Step S12 whether or not the image at a higher degree of resolution is demanded by the user specifying the segment. When so, the procedure jumps to Step S14 shown in FIG. 8. If not, the procedure goes to Step S13. When it is judged “not” at Step S13, the procedure returns to Step S10 where it is judged whether another request file is accessed or not by the user.

It is then examined at Step S14 whether the desired resolution segment of the image data has been decoded or not. When it is judged “not”, the procedure goes to Step S15 where the desired data or differentially encoded data are read out from the local HD 13 and decoded to reproduce high resolution images data through referring to the low resolution images. When it is judged “yes” at Step S14 or the action at Step S15 is completed, the procedure goes to Step S16 for displaying the desired segment of the images at a desired degree of resolution.

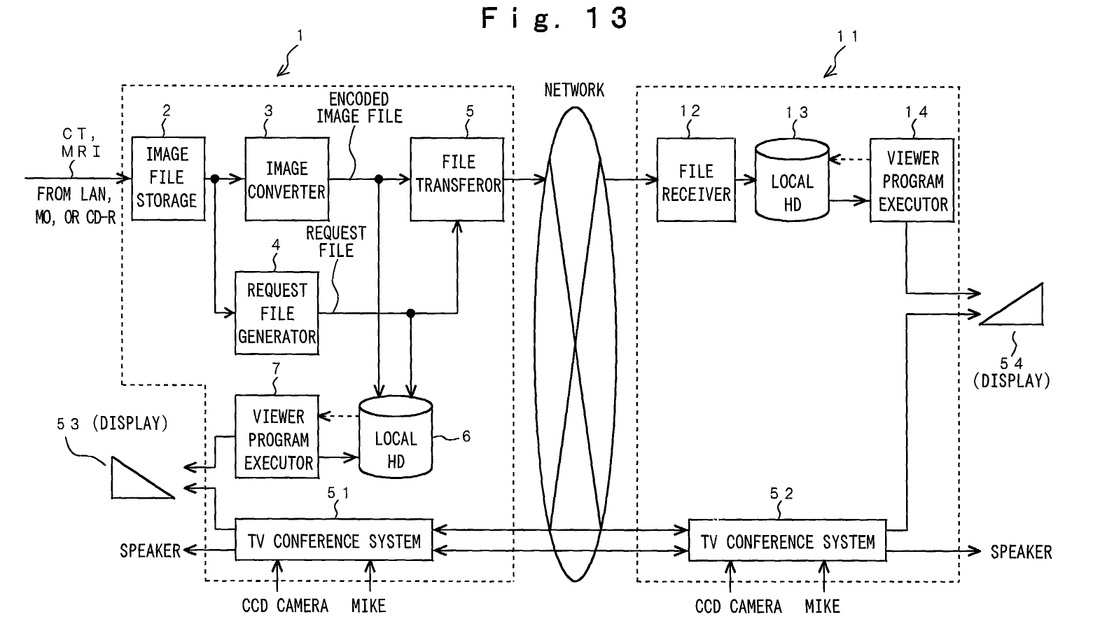

For example, when the segment d shown in FIG. 11 is desired for display at a higher degree of resolution at Step S12, it is enlarged at Step S16 and displayed throughout the screen (FIG. 12) with the lower right area showing the enlarged area frame in a thumb nail image. This allows the assigned expert to closely view a target to be examined in the enlarged image at a higher degree of resolution.

It is examined at Step S17 whether or not an action of image processing, such as a change in the gradation or a turn of the image, is desired. When it is judged so, the procedure goes to Step S18 for carrying out the action of image processing.

This is followed by Step S19 where it is examined whether or not the image is desired to return to the lower degree of resolution. When so, the procedure returns back to Step S9 for displaying the image at the lower degree of resolution. When not, the procedure advances to Step S20 where it is further examined whether or not another image, another segment of the image, or another degree of the resolution is desired. When not, the procedure returns back to Step S17. When so, the procedure returns back to Step S14. Finally, when the user demands the end of the action at Step S13, the procedure is terminated.

As set forth above, this embodiment allows the expert assigned for the specific diagnosis to easily identify in which (when) request the current case study is included and which case studies are included in the same request. Also, even if the medical images are received from two or more different hospitals or mixed with the saved images, the current case study can readily be identified over its origin and its time of reception.

In case that the images of two or more patients (case studies) have to be viewed at once, the procedure is returned back to Step S9 after the action of diagnosing one patient is completed by judging (“yes” at Step S19), where the lower resolution images and DICOM hierarchical architecture are displayed as shown in FIG. 11 for allowing the expert to select another patient using the DICOM hierarchical architecture. As a result, the shift from one patient to another can be hastened.

Moreover, when the medical images at a higher degree of the resolution are desired, their differentially encoded data can readily be retrieved from the hard disk and decoded with reference to the previously decoded image data. Accordingly, the amount of the data to be read out from the hard disk will be minimized and the higher resolution images will be displayed within a shorter period of time. More particularly, this permits the expert to view one patient to another as smooth as possible.

FIG. 13 illustrates another embodiment of the present invention where the system of the first embodiment is equipped with a TV conference function. In FIG. 13, like components are denoted by like numerals as those shown in FIG. 1 and will be described in no more detail.

As shown in FIG. 13, an encoder transmitter apparatus 1 is equipped with a local HD 6 and a viewer program executor 7 which are identical to those provided in the viewer terminal 11. As the local HD 6 saves the encoded image files generated in the image encoder 3 and the request file generated in the request file generator 4 which are also stored in the local HD 13 of the viewer terminal 11, the encoder transmitter apparatus 1 can have the same environment as of the viewer terminal 11. The encoder transmitter apparatus 1 and the viewer terminal 11 also include TV conference systems 51 and 52 respectively which are linked to each other for real-time two-way communications.

Accordingly, while each medical image is simultaneously displayed on both displays 53 and 54 provided respectively in the encoder transmitter apparatus 1 and the viewer terminal 11, dialogues for the diagnosis can be exchanged at real time between the two sides.

As described, the present invention allows the encoder transmitter apparatus to generate a request file which resides in a higher level of the DICOM hierarchical category. Therefore, the expert can easily identify in which (when) request the current case study is included and which case studies are included in the same request.

The viewer terminal has the viewer program executor arranged to have a function of analyzing each request file which displays a selection menu of the request file on a displaying means to indicate the DICOM hierarchical levels of the request file. This allows the expert to view two or more case studies at once and quickly select a desired patient to be examined through specifying the DICOM hierarchical category, hence improving the operability of the overall system.

Also, the medical images at a higher degree of resolution can be displayed by reading out the differentially encoded data of a desired segment of each image from the hard disk and decoding it with reference to the previously decoded data of the image. Accordingly, the overall amount of the data retrieved from the hard disk can be minimized and their medical images at a higher degree of resolution will be displayed within a shorter period of time.

Furthermore, the TV conference function permits the medical images to be simultaneously displayed and viewed monitored on both the encoder transmitter apparatus and the viewer terminal which can thus exchange dialogues for the particular action of diagnosis at real time.

What is claimed is:

1. An image transmitter apparatus comprising:
an image converter for generating files of hierarchically encoded image data;
a request file generator for generating a request file for the image data which is at a higher level of the DICOM hierarchy; and
a file transferor for releasing the encoded image data files generated by the image converter and the request file generated by the request file generator.

2. An image transmitter apparatus according to claim 1, wherein the request file includes the time of reception of a request, the name of a requester, the name of the request file, and the DICOM hierarchical category data.

3. An image transmitter apparatus according to claim 1, wherein the hierarchically encoded image data comprises the lowest degree of resolution generated by encoding the images and the higher degrees of resolution than the lowest generated by differentially encoding the images.

4. A received image viewing apparatus comprising:
a memory means for storing files of encoded image data generated by hierarchically encoding image data and a request file for the image data which is at a higher level of the DICOM hierarchy;
a means for analyzing the request file read out from the memory means; and
a displaying means for displaying a selection view of the request file to show the DICOM hierarchical category data assigned to the request file.

5. A received image viewing apparatus according to claim 4, wherein the selection view of the request file includes the name of the request file, the time of reception of a request, and the name of a requester.

6. A received image viewing apparatus according to claim 4, wherein the DICOM hierarchical category data has a four-level structure with the images at the lowest level and when a desired series in the four-level structure is selected, the images attributed to the series are displayed on the displaying means.

7. A received image viewing apparatus according to claim 5, wherein the DICOM hierarchical category data has a four-level structure with the images at the lowest level and when a desired series in the four-level structure is selected, the images attributed to the series are displayed on the displaying means.

8. A received image viewing apparatus according to claim 6, wherein the resolution of the images displayed on the displaying means can selectively be determined.

9. A received image viewing apparatus according to claim 7, wherein the resolution of the images displayed on the displaying means can selectively be determined.

10. An image transmission viewing apparatus with a TV conference function having;
the image transmitter apparatus defined in claim 1;
a memory means for storing at least the encoded image data files and the request file;
a displaying means for displaying desired images over the selection view of the request file read out from the memory means;
and a real-time two-way image data transmitting means with a TV conference function provided between the image transmitter apparatus and the received image viewing apparatus defined in claim 4.
